(19) United States
(12) Patent Application Publication
(10) Pub. No.: US 2013/0346492 A1
(43) Pub. Date: Dec. 26, 2013

(54) Content Reading System and Method

(71) Applicant: Sursen Corp., Beijing (CN)

(72) Inventors: Donglin Wang, Beijing (CN); Han Hao, Beijing (CN)

(73) Assignee: SURSEN CORP., Beijing (CN)

(21) Appl. No.: 14/020,201

(22) Filed: Sep. 6, 2013

Related U.S. Application Data
(63) Continuation of application No. PCT/CN2012/072090, filed on Mar. 8, 2012.

(30) Foreign Application Priority Data
Mar. 8, 2011 (CN) 2011100559869

(51) Int. Cl. H04L 29/06

(52) U.S. Cl. CPC H04L 29/06047
USPC 709/203

(57) ABSTRACT

The present invention provides a content reading system and method, which gives consideration to both the flexibility of reading method and the security of copyright protection. The content reading system includes: a Document Management System DCMS server, adapted to support the storage and parsing of data content; invoke stored page data and provides the page data to a dedicated client after receiving a page data request from the dedicated client; invoke stored page data to form bitmap of the page and provides the bitmap to a Web client after receiving a page data request from a Web client.

### CROSS-REFERENCE TO RELATED APPLICATIONS

This application is a continuation of PCT/CN2012/070290 filed Mar. 8, 2013, which claims priority from Chinese patent application 201110055986.9, filed on Mar. 8, 2011, the entire contents of which are incorporated herein by reference for all purposes.

### FIELD OF THE INVENTION

The present invention relates to the computer network technology, and more particularly, to a content reading system and method.

### BACKGROUND OF THE INVENTION

The traditional super distribution-based digital copyright protection technology protects the security of digital content by encrypting the content, distributing the content arbitrarily, and obtaining the authorization to achieve the decryption key. Such copyright protection technology introduces a risk that the encrypted content is easy to be distributed. The attacker may easily obtain the complete (encrypted) digital content, and then use a variety of techniques to study and crack the digital content.

Therefore, a new content reading method is required for convenient and flexible content reading and secure copyright protection.

### SUMMARY OF THE INVENTION

Embodiments of the present invention mainly provides a content reading system and method, which give consideration to both the flexibility of reading method and the security of copyright protection.

One embodiment of the present invention provides a content reading system, which includes:

a Document Management System DCMS server, adapted to support the storage and parsing of page data; invoke stored page data and provides the page data to a dedicated client after receiving a page data request from the dedicated client; invoke stored page data to form bitmap of the page data and provides the bitmap to a Web client after receiving a page data request from a Web client.

One embodiment of the present invention also provides an online reading method, which includes:

storing and parsing, by a Document Management System DCMS server of, page data;

invoking stored page data and providing the page data to a dedicated client after receiving a page data request from the dedicated client;

invoking stored page data to form bitmap of the page data and providing the bitmap to a Web client after receiving a page data request from the Web client.

By using the technical scheme in the embodiments of the present invention, a user may read online through a dedicated client or a Web client. The is distribution of the page data content is performed by the DCMS server to ensure the security.

### BRIEF DESCRIPTION OF THE DRAWINGS

FIG. 1 illustrates the structure of a reading system provided in one embodiment of the present invention.

FIG. 2 illustrates the overall architecture of a DCMS server provided in one embodiment of the present invention.

FIG. 3 illustrates the inner structure of a dedicated client provided in one embodiment of the present invention.

FIG. 4 illustrates the structure of an online reading system based on WEB provided in one embodiment of the present invention.

FIG. 5 illustrates the structure of the Web generation server provided in one embodiment of the present invention.

### DETAILED DESCRIPTION OF THE INVENTION

The embodiments of the present invention are described more fully hereinafter with reference to the accompanying drawings, which form a part hereof, and which show, by way of illustration, specific exemplary embodiments by which the invention may be practiced. This invention may, however, be embodied in many different forms and should not be construed as limited to the embodiments set forth herein; rather, these embodiments are provided so that this disclosure will be thorough and complete, and will fully convey the scope of the invention to those skilled in the art. Among other things, the present invention may be embodied as systems, methods or devices. The following detailed description should not to be taken in a limiting sense.

Throughout the specification and claims, the following terms take the meanings explicitly associated herein, unless the context clearly dictates otherwise. The phrase “in one embodiment” as used herein does not necessarily refer to the same embodiment, though it may. Furthermore, the phrase “in another embodiment” as used herein does not necessarily refer to a different embodiment, although it may. Thus, as described below, various embodiments of the invention may be readily combined, without departing from the scope or spirit of the invention.

In addition, as used herein, the term “or” is an inclusive “or” operator, and is equivalent to the term “and/or,” unless the context clearly dictates otherwise. The term “based on” is not exclusive and allows for being based on additional factors not described, unless the context clearly dictates otherwise. In addition, throughout the specification, the meaning of “a,” “an,” and “the” include plural references. The meaning of “in” includes “in” and “on.” The term “coupled” implies that the elements may be directly connected together or may be coupled through one or more intervening elements. Further reference may be made to an embodiment where a component is implemented and multiple like or identical components are implemented.

While the embodiments make reference to certain events this is not intended to be a limitation of the embodiments of the present invention and such is equally applicable to any event where goods or services are offered to a consumer.

Further, the order of the steps in the present embodiment is exemplary and is not intended to be a limitation on the embodiments of the present invention. It is contemplated that the present invention includes the process being practiced in other orders and/or with intermediary steps and/or processes.

In the following content, we give a further description of the present invention in conjunction with appended drawings.

Embodiments of the present invention provide a content reading system, which uses an online content server to provide contents for both dedicated client and general browser. In brief, the content reading system proposed in the embodiment of the present invention uses a Document Management System. DCMS server to support the storage and parsing of page data. The DCMS server invokes stored page data and provides the page data to a dedicated client after is receiving a page data request from the dedicated client. The DCMS server invokes stored page data to form bitmap of the page and provides the bitmap to a Web client after receiving a page data request from a Web client.

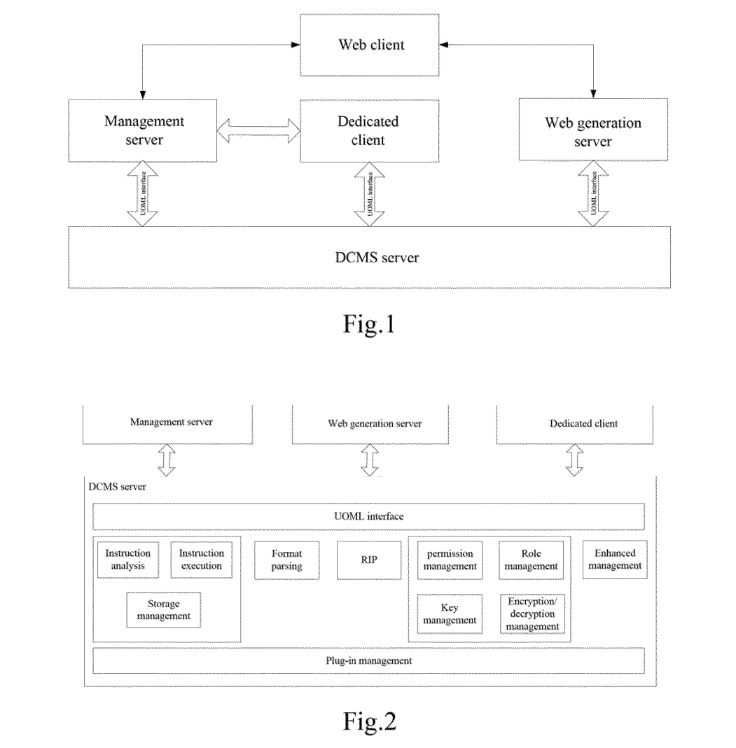

FIG. 1 shows the overall architecture of an online content server provided in the present invention. The interfaces among sub-modules, the interface between the sub-module and an external dedicated client, the interface among Web general clients are also shown in FIG. 1. The overall online content server comprises a DCMS server, a Web generation server, and a management server.

The DCMS server supports the storage and parsing of data content. When receiving a page data request from the dedicated client, the DCMS server directly invokes the page data stored and provides the page data to the dedicated client. When receiving a page data request from a Web client, the DCMS server invokes the stored page data, performs format parsing and RIP rendering on the page data, forms bitmap of the page data, and provides the bitmap to the Web generation server.

The DCMS server is further responsible for fine-grained control and role management. When the dedicated client and the Web client authenticate the user through the management server, the management server invokes the DCMS server to achieve the corresponding role information and returns it back to the dedicated client and the Web client. The dedicated client and the Web client use the role information to access the DCMS server.

The Web generation server obtains the bitmap data of the page through the DCMS server, segments and mixes the data, generates a JavaScript program, and transmits the program to the Web client. The program can be executed automatically to reorganize the segmented fragments as the bitmap and display it at the Web client side. The skilled in the art can understand that the objective of mixing data fragments is to ensure the security of the data. The mixing process can be omitted in some embodiments. Furthermore, the Web generation server inquires the access control of the bitmap through the DCMS server.

The management server provides functions of public system management, user management, content management, and interface management for the DCMS server and the Web generation server.

The dedicated client and the Web client authenticate the user and access the user information through the login management server. The management server implement above functions by invoking the DCMS server.

The DCMS server supports the UOML standard interface. The management server, the Web generation server, and the dedicated client invoke the corresponding functions of the DCMS server through the UOML standard interface. The management server communicates with the dedicated client and the Web client through the user management interface. The Web generation server communicates with the Web client via the HTTP protocol.

The skilled in the art can understand that the main function of the management server is to provide user authentication and user interface management. For the purpose of online content reading, the management server may be omitted in some embodiments.

The DCMS server includes a core module, a format parsing module, a rendering module, a security control module, and a plug-in management module, as shown in FIG. 2.

The core module is adapted to store page data.

The format parsing module is adapted to parse to parse the stored page data.

The rendering module is adapted to render the parsed data to create the bitmap of the page data.

When the Web generation server requires the DCMS server for the bitmap of the page data, the format parsing module and the rendering module are invoked.

The security control module is adapted for role management, permission management, key management, encryption/decryption management, and signature watermark management, and may include a role management module, a permission management module, a key management module, an encryption/decryption management module, and a signature watermark management module.

These modules are basic modules of the DCMS server. The execution of each instruction may invoke these modules. For example, the management server invokes the role management module to obtain the role login information. When logging in and accessing the DCMS server as a role, the dedicated client may invoke the permission management module to judge the role's permission, and also may invoke the encryption/decryption management module and the key management module to perform the encryption/decryption of the page data and the permission data. When providing the page data to the dedicated client or providing the bitmap of the page to the Web generation server, the DCMS server may invoke the signature watermark management module to insert signatures and watermarks into the data to ensure the security of the data.

The plug-in management module is adapted to manage and invoke plug-ins, to extend the functionality of the DCMS server.

When the DCMS server communicates with the external through the UOML standard, the DCMS server further includes: a UOML interface, adapted to communicate with external servers or clients. In this case, the core module is further adapted to parse and execute UOML instructions.

In an embodiment, the DCMS server encrypts the data at least twice, which includes following steps.

The data is encrypted when stored in the DCMS server, wherein, the part of the key for encrypting is a fixed key from the key management module, and the other part is a random key (which is stored in the ciphertext data).

For the second time of encryption, the ciphertext is bound with the service on which the data is secondly encrypted. Even if the insider gets the ciphertext, he/she can neither decrypt the ciphertext to get the plaintext, nor use it in another server, which ensures the security of the encrypted data stored in the server.

Before the data is transmitted, from the DCMS server to the dedicated client, the secondly encryption is decrypted, and the decrypted data is encrypted by a dynamic key and a dynamic security channel is used to transmit the encrypted data. Even if the data package is intercepted during the transmission, it is impossible to decrypt the intercepted data to get the plaintext, and it is invalid to send the same data package to another client or the same client.

By using this method, during distribution and content displaying, one can prevent the digital content (encrypted digital content or plaintext) from being achieved by the attacker, and can realize the fine-grained permission control to ensure the user cannot access the digital, content without any permission.

The skilled in the art can understand that, in embodiments where only the online reading through the dedicated client is supported, the abovementioned DCMS server may include only the UOML interface and the core module. In embodiments where only the online reading through the Web client is supported, the abovementioned DCMS server may include only the UOML interface, the core module, the format parsing module, and the rendering module.

The connection between the dedicated client and the online content server is in C/S mode. When a user logs in through the dedicated client, the dedicated client gets the data content from the DCMS server and displays it to the user. In one embodiment of the present invention, the dedicated client gets the encrypted data content from the DCMS server, and decrypts the data. The received encrypted data content has been encrypted twice. One encryption corresponds to the dynamic channel encryption, and the other corresponds to the encryption performed when the data is stored in the server. After receiving the data, the dedicated client decrypts the dynamic channel encryption, and maintains the encryption performed in the storage. The client only allows temporarily storing the data (encrypted digital content or unencrypted digital content) in the memory, and forbids storing the data in permanent storage media including the hard disk. When the data needs to be displayed in the dedicated client, the data is decrypted and parsed at the same time. Moreover, the real-time decryption technology is used to decrypt the encrypted file to prevent the plaintext from being intercepted from the memory.

By using such dedicated client, the security performance may be maximized. No data is retained in the hard disk in the whole data processing. Neither plaintext nor ciphertext is allowed to be stored in the permanent storage media of the client. Meanwhile, functions of the client can be prohibited according to the user's corresponding permission, to prevent the data content from being intercepted illegally.

More importantly, the dedicated client completely uses the proprietary code to parse the data. The parsing and displaying of the digital content do not depend on the third-party product, which further prevents the data interception in the operating system level. After the data is displayed, the anti-screenshot technique may be used to avoid the information interception via the screenshot.

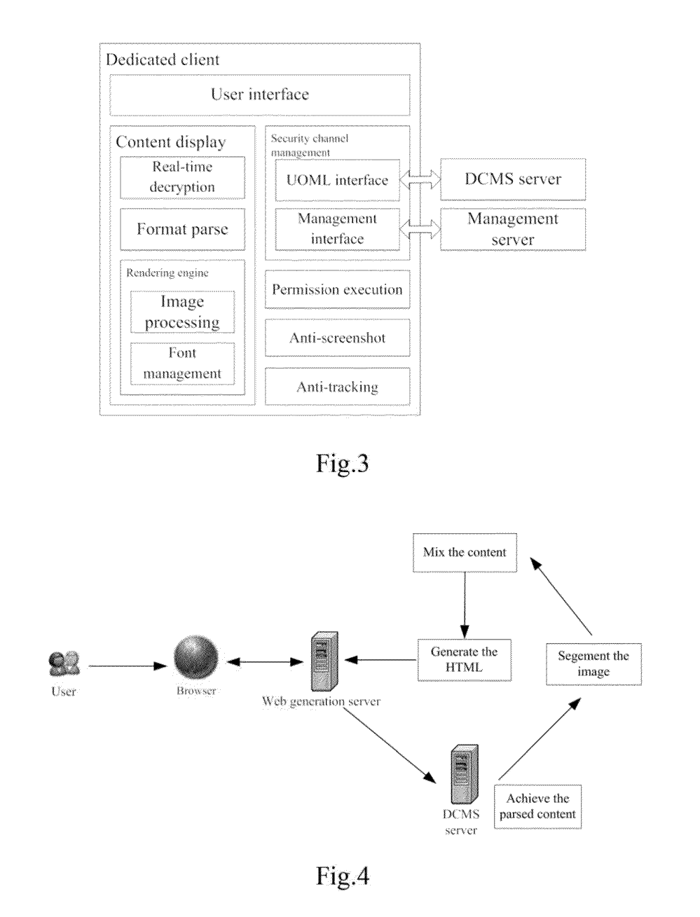

FIG. 3 illustrates the inner structure of a dedicated client provided in one embodiment of the present invention. As shown in FIG. 3, a dedicated client includes a content display module, a permission execution module, an anti-screenshot module, a user interface module, a security channel management module, and an anti-tracking module.

The content display module is adapted to process online digital content in real time, and display the online digital content to the user through the user interface. The content display module includes a real-time decryption unit, a format parsing unit, and a rendering engine unit. The real-time decryption unit is adapted to decrypt digital content from the security channel and achieve the format data stream in plaintexts. Those skilled in the art can understand that the real-time decryption unit is required only when the received data content has been encrypted. The format parsing unit is adapted to parse the format data stream achieved after the real-time decryption, and obtain the primitive objects that could be directly rendered, such as texts, graphics, images, control instructions, and font data. The rendering engine unit is adapted to display the primitive objects from format data streams on monitors, printers, and other devices. During the rendering process, according to the actual need, the image processing unit is invoked to process the image data of different formats, or the font management unit is invoked to process the font data of different formats.

The security channel management module is adapted to establish security channel used for the interaction (such as UOML instruction) between the DCMS server and the management server, including the transmission of digital content and permission data. If the DCMS server does not include the management server, the security channel management module does not include a management interface.

The permission execution module is adapted to control the behavior of the client according to the user permission data from the DCMS server.

The anti-screenshot module is adapted to prohibit the screenshot operation and prevent the protected digital content from being intercepted via the screenshot.

The anti-tracking module is adapted to prevent users from attacking the copyright protection mechanism, harming the system security, or stealing the protected digital content, according to the implementation principle of tracking software and technologies.

The user interface module is adapted to provide the interface to the user for displaying the digital content, and provide a lot of easy-to-use user interaction functions.

Those skilled in the art can understand that, the permission execution module is used to ensure the user's execution permission, the anti-screenshot and the anti-tracking module are used to ensure the security of the data content and the software content, and the user interface module is used to ensure a user-friendly operation interface. In some embodiments of the present invention, the dedicated client could use none of these modules, or only use a subset of these modules.

The connection between the Web client and the Web generation server are in B/S mode. The user could read the digital content after logging in any Web client. The data parsing, generation, and display functions of the Web client are all realized at the server side. When the user requires the Web generation server for the page data, the Web generation server invokes the DCMS server through the UOML interface. The DCMS server extracts the corresponding page data, performs the format parsing and RIP rendering on the data, forms the bitmap of the page, and returns the bitmap to the Web generation server. The Web generation server segments the page data into fragments according to certain segmentation algorithm, creates the JavaScript program and sends the program to the Web client. The Web client automatically executes the JavaScript program, invokes fragments and reorganizes fragments, forms the complete HTML webpage and displays it. The mixing technique may be used to further guarantee the system security by mixing the data and obfuscating the JavaScript program. By using this method, the user may safely read the digital content directly through the browser without installing reading software.

FIG. 4 illustrates the structure of an online reading system based on WEB provided in one embodiment of the present invention. The whole online reading process after the user logs in to the Web client can be easily understood according to the flow diagram provided by the present embodiment.

Step 1: The user opens the browser, accesses the management server through the browser, and prepares to browse the content after authentication.

Step 2: The browser issues a reading request to the Web generation server.

Step 3: The Web generation server invokes the DCMS server and obtains the parsed data content. In this embodiment, the data content is image data of a page.

Step 4: The Web generation server segments the image data of the page into fragments.

Step 5: The Web generation server mixes the segmented fragments, stores the mixed data in the server, and uses the HTML code to record the URL address of fragments.

Step 6: The Web generation server creates a JavaScript program, and sends the program to the browser.

Step 7: The browser automatically performs the JavaScript program, invokes the HTML code and the image fragments, reorganizes fragments into HTML page by using the JavaScript program, and displays the HTML page to the user.

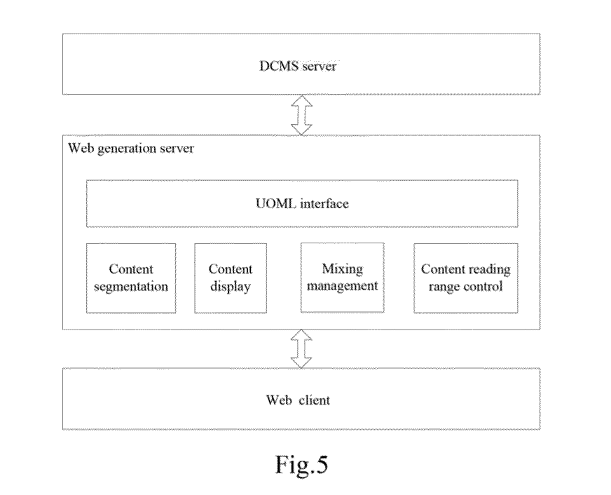

FIG. 5 illustrates the structure of the Web generation server provided in one embodiment of the present invention. As shown in FIG. 5, the Web generation server includes a content segmentation module, a content display module, a dynamic content mixing module and a content reading control module. The Web generation server connects the DCMS server through the UOML interface, and communicates with the Web client via network protocols including HTTP protocol.

The content segmentation module is adapted to segment the bitmap of the page to be returned from the DCMS server into fragments. The content mixing module is adapted to mix segmented fragments. After the segmenting and mixing processes, even if the fragments are obtained by a pirate, it takes a lot of time to reorganize fragments into a new image. As mentioned above, the mixing process guarantees the security of the data. The mixing process may be omitted in some embodiments.

The system provides two kinds of segmentation strategies, the static segmentation and the dynamic segmentation. The static segmentation refers to segmenting the bitmap according to fixed rules. The segmentation algorithm will not change within a period of time. The fragments are cached so that no real-time segmentation is needed when the same data is requested again. The static segmentation may be used when the data volume is huge and the data security requirement is not strict.

The dynamic segmentation refers to segmenting the bitmap according to an algorithm randomly extracted from a segmentation algorithm library each time. Different images may use different segmentation algorithms. In this case, the segmentation is usually performed in real time according to the user's request. The dynamic segmentation may be used when the data volume is small and the data security requirement is strict.

The system may modify the configuration file to change the segmentation strategy according to the data volume and the security requirement.

The simplest segmentation algorithm is to segment the image into M*N columns. M and N are relatively fixed, i.e., each row has the same column number. For example, the image is segmented into 3*3 fragments. The row number and the column number should not be set too large, in order to control the segmentation speed.

Instead of simply segmenting the image into M*N columns, a complex segmentation algorithm segments the bitmap into rows, where different rows have different column numbers. For example, the first row is segmented into two columns, the second row is segmented into four columns, . . . , and the M-th row is segmented into 2M columns. Parameters of the segmentation algorithm may be set by the administrator according to the system condition.

Parameters of the segmentation algorithm also include the page number of the document. In this way, it is possible to segment the images of different pages in one publication by using different segmentation algorithms.

In addition, the parameters of the segmentation algorithm also include user name, i.e., choosing a segmentation algorithm according to the user name. In this way, it is possible to segment the images for different users by using different segmentation algorithms.

Take a complex algorithm as an example, where parameters of the segmentation algorithm include the user name.

Three parameters as follows are calculated firstly.

User Key: MD5(MD5(User name+Salt)), i.e., the salt is added to the user name, and the MD5 calculation is performed on the salted, data to achieve the user key.

Title request instruction: the title request instruction is obtained by symmetric encrypting (user name+title) and using the user key. The server can check whether it is a legitimate access according to the title request instruction. The server can use the reverse algorithm to get the related information of user name and title, and then check the corresponding information in the title request instruction of the session to judge whether it is a legitimate access.

Page request instruction: the page request instruction is obtained by symmetric encrypting (user name+title+page) and using the user key. The server can check whether it is a legitimate access according to the page request instruction. The server can use the reverse algorithm to get the related information of user name, title and page, and then check the corresponding information in the page request instruction of the session to judge whether it is a legitimate access.

A timestamp is added to each instruction. The instruction is valid only within the scope of the timestamp to guarantee the security. When the instruction is sent to the server, its digital signature is also checked in the server. If the instruction exceeds the valid time, it will be ignored to avoid the falsification.

The row number of the segmentation is: Md5(page request instruction+salt) % the maximum row number. The maximum row number may be defaulted, or changed adaptively according to the screen of the user terminal and the display font.

The column number of the segmentation is: Md5 (page request instruction+row number+salt figure) % the maximum column number. The maximum column number may be defaulted, or changed adaptively according to the screen of the user terminal and the display font.

The image fragments after segmentation are stored in the server side with their URL addresses recorded in an HTML code. When the HTML code is invoked, the corresponding image fragments are invoked in turn to reorganizate is to form an HTML webpage.

The content display module is adapted to reorganize the data fragments and display the reorganized data in the Web client.

After the authentication of the page request instruction is passed, the server directly exports the JavaScript code. JavaScript requires the server for the HTML code that records the URL address of image fragments. The reorganization of fragments is performed at the server side and not by JavaScript. JavaScript only needs to send the HTML code to the Web client.

JavaScript code is dynamically generated at the server side. Each user receives a unique JavaScript code.

Once the image segmentation algorithm is confirmed, the image combination algorithm is confirmed by which the fragments can be reorganized.

The process of JavaScript invoking and displaying the image at client side may include following steps. The JavaScript invokes the HTML code in the server, and hence invokes the image data. In this case, the JavaScript code may be processed by the code obtuscation technique, the HTML code and the image data may be processed by the data obfuscation technique.

To provide a higher security, the process of JavaScript invoking and displaying the image at client side may include following steps. The JavaScript invokes the Web service at the server side, invokes the HTML code in the server, and finally invokes the image data. In this case, the JavaScript at client side does not directly invoke the HTML code, however, the JavaScript invokes the Web service, and then the Web service invokes the HTML. In this case, the JavaScript code at client side may be processed by the code obfuscation technique, and the Web service code at server side may be processed by the code obfuscation technique or/and the data obfuscation technique. The HTML code and the image data may be processed by the data obfuscation technique.

To guarantee the security of Web browsing, user interface control codes are inserted into the JavaScript program, which prevent a user from copying the page content through the browser interface (“right-click menu”, “browser menu”, “Ctrl+C shortcut”, etc.).

The content reading range control module is adapted to control the security accessing of the data content to prevent a user from illegally stealing the data content, i.e., controlling which range of the data content may be accessed by the user. This module may be omitted in practical applications.

Those skilled in the art can understand that all modules in the present invention are divided based on logical level instead of the physical structure. For example, two modules presented in the embodiment of the present invention may be realized in one entity in the practical product, while one module may be realized in two entities in the practical product. Furthermore, the module name in the present invention only serves as a mark instead of limiting the function and scope of the module.

One embodiment of the present invention also provides an online reading method, which includes following steps:

storing and parsing, by a Document Management System DCMS server of, data content;

invoking stored page data and providing the page data to a dedicated client after receiving a page data request from the dedicated client;

invoking stored page data to form bitmap of the page data and providing the bitmap to a Web client after receiving a page data request from the Web client.

Specifically, the technical schemes in the above embodiment are all applicable to the online reading method provided in the embodiment.

The above content only includes preferred embodiments of the present invention. The content is not used to limit the protection scope of the protection. Any modification, replacement, and improvement made under the design idea and the design principle will be considered to be within the protection scope of the present invention.

1. A content reading system, comprising:
a Document Management System DCMS server, adapted to support the storage and parsing of page data; invoke stored page data and provides the page data to a dedicated client after receiving a page data request from the dedicated client; invoke stored page data to form bitmap of the page data and provides the bitmap to a Web client after receiving a page data request from a Web client.

2. The system of claim 1, further comprising:
a Web generation server, adapted to achieve the bitmap of the page data from the DCMS server, segment the bitmap into fragments, create an executable program that could rearrange fragments into the bitmap, and provide fragments and the executable program to the Web client.

3. The system of claim 1, further comprising:
a management server, adapted to provide functions of system management, and/or user management, and/or content management.

4. The method of claim 1, wherein, the DCMS server comprises:
Module 1, adapted for storage and manage the page data;
Module 2, adapted to parse the page data stored in Module 1;
Module 3, adapted to render the page data parsed by Module 2 and form the bitmap of the page data.

5. The system of claim 4, wherein, the DCMS server further comprises:
Module 4, adapted for role management, and/or permission management, and/or key management, and/or encryption/decryption management, and/or signature watermark management.

6. The system of claim 1, further comprising:
the dedicated client, adapted to achieve the page data from the DCMS server, parse the page data and present the parsed page data to the user.

7. The system of claim 6, wherein, the dedicated client comprises:
Module 5, adapted to perform format parsing and rendering on the page data achieved from the DCMS server.

8. The system of claim 7, wherein, the dedicated client further comprises:
Module 6, adapted to control the user behavior according to the user permission data from the DCMS server.

9. The system of claim 2, wherein, the Web generation server comprises:
Module 7, adapted to segment the bitmap from the DCMS server into fragments;
Module 8, adapted to create the executable program that could rearrange fragments into the bitmap and present the bitmap at the Web client.

10. The system of claim 9, wherein, the Web generation server further comprises:
Module 9, adapted to mix the segmented fragments;
Module 10, adapted to control the security access of the bitmap.

11. The system of claim 2, wherein the connection between the DCMS server and the Web generation server is via the document management standard interface.

12. The system of claim 6, wherein the connection between the DCMS server and the dedicated client is via the document management standard interface.

13. An online reading method, comprising:
storing and parsing, by a Document Management System DCMS server of, page data;
invoking stored page data and providing the page data to a dedicated client after receiving a page data request from the dedicated client;
invoking stored page data to form bitmap of the page data and providing the bitmap to a Web client after receiving a page data request from the Web client.

14. The method of claim 13, wherein invoking stored page data to form bitmap of the page data and providing the bitmap to a Web client after receiving a page data request from the Web client comprises:
invoking the stored page data, parsing and rendering the stored, page data, to form the bitmap of the page.

15. The method of claim 14, after the bitmap of the page is formed, further comprising:
segmenting the bitmap into fragments, creating an executable program that could reorganize fragments into the bitmap, and providing fragments and the executable program to the Web client.

16. The method of claim 15, further comprising:
mixing the segmented fragments;
rearranging, by the executable program, the segmented and mixed fragments into the bitmap to be presented in the Web client; and/or,
controlling the security access of the bitmap.

17. The method of claim 15, wherein, segmenting the bitmap comprises:
segmenting the bitmap according to fixed rules or an algorithm randomly extracted from the segmentation algorithm library.

18. The method of claim 17, wherein, the segmentation algorithms comprises:
segmenting the bitmap into fixed rows and columns or into rows, where different rows have different column numbers; or into columns, where different columns have different row numbers.

19. The method of claim 17, wherein, parameters of the segmentation algorithm comprises user information and/or feature information of the page data.

20. The method of claim 13, after invoking stored page data and providing the page data to a dedicated client after receiving a page data request from the dedicated client, further comprising:
performing, by the dedicated client, format parsing and rendering on the received page data.
